(19) United States
(12) Patent Application Publication
(10) Pub. No.: US 2017/0130314 A1
(43) Pub. Date: May 11, 2017

(54) Method for the Production of a Particle-Containing Aerosol

(71) Applicant: Eckart GmbH, Hartenstein (DE)

(72) Inventors: Harald Wagner, Hartenstein (DE); Uwe Ott, Nurnberg (DE); Kerstin Schindler, Eckental (DE); Christian Wolfrum, Erlangen (DE); Markus Rupprecht, Edelsfeld (DE)

(21) Appl. No.: 15/321,786

(22) PCT Filed: Jun. 25, 2015
(86) PCT No.: PCT/EP2015/064470

§ 371 Date: Dec. 23, 2016

(30) Foreign Application Priority Data
Jun. 26, 2014 (EP) 14174601.6

(51) Int. Cl. C23C 4/134; B22F 1/02; C23C 4/08; C23C 4/129; C23C 24/04; C08K 3/08; C04B 14/30; C04B 14/22; C04B 14/34; C04B 26/28; C04B 26/06; B22F 1/00; C04B 30/00

(52) U.S. Cl. CPC C23C 4/134; B22F 1/007; B22F 1/025; C23C 4/08; C23C 4/129; C23C 24/04; C04B 30/00; C04B 14/303; C04B 14/22; C04B 14/34; C04B 26/285; C04B 26/06; C08K 3/08; B22F 2301/10; B22F 2301/052; B22F 2998/10; B22F 2304/10; C04B 2111/00155

(57) ABSTRACT

The present invention relates to a method for the production of a particle-containing aerosol, which includes comminutating a particle-containing cylinder. These aerosols are for example particularly suitable for use in the form of an aerosol stream in a coating process. The present invention further relates to particle-containing cylinders which can be dispersed and converted into aerosol form by simple methods.

The present invention relates to particle-containing cylinders, which can be dispersed and converted into aerosol form by simple methods. These aerosols are particularly suitable for use in the form of an aerosol stream in a coating process.

The conversion of a powder material into an aerosol, in order for example to use it in flame spraying, is the subject of various patent applications such as U.S. Pat. No. 4,997,318 B1 and U.S. Pat. No. 6,331,689 B1. U.S. Pat. No. 4,660,986 A also concerns the delivery of a powder, which is however associated with a very high equipment cost.

It has been found that with known delivery methods, uniform delivery of particles in particular for achieving homogeneous coatings is difficult to impossible to effect.

However, such uniform delivery is important for example for coating processes, since the quality of a coating is also dependent on its uniformity. This applies in particular when a coating which is as thin as possible and nonetheless reliable is to be obtained. Known methods for example use kinetic energy, thermal energy or mixtures thereof for creating the coatings, where the thermal energy can for example derive from a conventional combustion flame or a plasma flame. The latter are further subdivided into thermal and non-thermal plasmas, having in common the fact that a gas is partially or completely separated into free charge carriers such as ions or electrons.

In cold gas spraying, the formation of the coating is effected by application of a powder onto a substrate surface, with the powder particles being strongly accelerated. For this, a heated process gas is accelerated to supersonic velocity by expansion in a Laval nozzle and the powder then injected. Because of the high kinetic energy, the particles form a thick layer on impinging on the substrate surface.

For example WO 2010/003396 A1 discloses use of cold gas spraying as a coating process for the application of anti-wear protective coatings. Furthermore, there are disclosures of the cold gas spraying process for example in EP 1 363 811 A1, EP 0 911 425 B1 and U.S. Pat. No. 7,740,905 B2.

Flame spraying belongs to the group of the thermal coating processes. In this, a powdery coating material is introduced into the flame of a fuel gas-oxygen mixture. Thus, for example with acetylene-oxygen flames, temperatures of up to approximately 3200° C. can be reached. Details of the method can be obtained from publications such as for example EP 830 464 B1 and U.S. Pat. No. 5,207,382 A.

In thermal plasma spraying, a powdery coating material is injected into a thermal plasma. In the thermal plasma typically used, temperatures of up to ca. 20000 K are reached, as a result of which the injected powder fuses and is deposited as a coating on a substrate.

The method of thermal plasma spraying and specific embodiments and process parameters are known to those skilled in the art. By way of example, reference is made to WO 2004/016821, which describes the use of thermal plasma spraying for applying an amorphous coating. Further, for example EP 0 344 781 discloses the use of flame spraying and thermal plasma spraying as coating methods using a tungsten carbide powder mixture. Specific devices for use in plasma spray methods are frequently described in the literature, for example in EP 0 342 428 A2, U.S. Pat. No. 7,678,428 B2, U.S. Pat. No. 7,928,338 B2 and EP 1 287 898 A2.

In high velocity flame spraying, a fuel is burnt under high pressure, for which both fuel gases, liquid fuels and mixtures thereof can be used as fuel. A powdery coating material is injected into the highly accelerated flame. This method is known to be characterized by relatively thick sprayed layers. High velocity flame spraying is also well known to those skilled in the art and has already been described in many publications. For example, EP 0 825 272 A2 discloses a substrate coating with a copper alloy using high velocity flame spraying. Further, for example WO 2010/037548 A1 and EP 0 492 384 A1 disclose the method of high velocity flame spraying and devices for use therein.

Non-thermal plasma spraying takes place largely analogously to thermal plasma spraying and flame spraying. A powdery coating material is injected into a non-thermal plasma and thereby applied onto a substrate surface. As can for example be seen from EP 1 675 971 B1, this method is characterized by particularly low thermal stress on the coated substrate. This method, particular embodiments and appropriate process parameters are also known to those skilled in the art from various publications. For example, EP 2 104 750 A2 describes the use of this method and a device for its implementation. For example, DE 103 20 379 A1 describes the production of an electrically heatable element using this method. Further disclosures regarding the method or devices for non-thermal plasma spraying are for example to be found in EP 1 675 971 B1, DE 10 2006 061 435 A1, WO 03/064061 A1, WO 2005/031026 A1, DE 198 07 086 A1, DE 101 16 502 A1, WO 01/32949 A1, EP 0 254 424 B1, EP 1 024 222 A2, DE 195 32 412 A1, DE 199 55 880 A1 and DE 198 56 307 C1.

However, a general problem of coating methods using particulate coating materials is that in order to create a homogeneous but thin coating, very high homogeneity of the particle aerosol used is necessary. Admittedly, for example in the documents discussed at the outset, special equipment methods for obtaining homogeneous aerosols are described. In practice, the technical implementation at least on the industrial scale was found to be difficult or at least of little interest on account of the equipment cost.

Consequently, one purpose of the present invention is to provide a simple method for uniform particle delivery and the means required for this. Aerosol streams which can advantageously be used in coating processes should thereby be obtained. At the same time, the lowest possible equipment requirements should be placed on the powder delivery and broad spectra of particles should be usable without major equipment adaptations. This problem is solved by the subjects, methods and uses stated in the claims and aspects.

The present invention relates to a method for the production of a particle-containing aerosol, wherein the cylinder has a volume of at least 5 cm³ and is dimensionally stable,

the content of particles lies in the range from 10 wt. % to 99.9 wt. %, based on the total weight of the cylinder,
the bending strength σ is at most 3.75 N/mm², where σ is calculated according to formula (I)

$$σ = \frac{3 \times F \times l}{2 \times B \times {D}^{2}} \qquad ( I )$$

with F=maximum force, B=width of the cylinder in rectangular shape, D=height of the cylinder in rectangular shape, l=distance between the two points of support
the particles are selected from the group consisting of metal particles, glass particles, mica particles, ceramic particles and mixtures thereof
the particles contained in the cylinder have a d₅₀ of at most 300 μm and the cylinder contains at least 0.01 wt. % of binder, based on the total weight of the particle-containing cylinder, where the binder is selected from the group consisting of inorganic binders, organic binders and mixtures thereof. In the context of the invention, it naturally applies that the sum of all wt. % of the components of a cylinder according to the invention can in total amount to at most 100 wt. %. Preferably the inorganic binders are selected from the group consisting of calcium sulphate, talc, calcium hydroxide, silicon oxide, aluminium oxide, calcium carbonate, calcium silicate hydrates, calcium aluminate hydrates and mixtures thereof. The organic binders are preferably selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, still more preferably from the group consisting of cellulose, cellulose derivatives, polysaccharides, gelatine, polyvinyls, polyacrylates, polyethylene oxides, polyethylene glycols, polyamides, epoxy resins, the salts of the aforesaid substances and mixtures thereof.

The term “polyacrylate copolymers” in the sense of the present invention designates appropriate copolymers which are not comprised by the term polyacrylate. Examples of these are styrene-acrylate copolymers.

The term “polyaldehyde copolymers” in the sense of the present invention designates appropriate copolymers which are not comprised by the term polyaldehyde. Examples of these are cyclohexanone-formaldehyde copolymers.

The term “polyolefin copolymers” in the sense of the present invention designates appropriate copolymers which are not comprised by the term polyolefin.

The term “polyolefin” in the sense of the present invention designates corresponding polymers which are not comprised by the term polyvinyl.

The term “cylinder” in the sense of the present invention is essentially understood to mean the geometrical basic shape known as cylinder, i.e. a body bounded by two parallel, planar, congruent surfaces (base and top surface) and an envelope or cylinder surface, wherein the envelope surface is formed by parallel straight lines. According to the invention, the term cylinder in the sense of the present invention also comprises theoretically infinite cylindrical shapes which are for example obtained by means of continuous extrusion. However, the cylinders of the present invention are preferably individual cylinders, with the length thereof preferably being less than 2 metres, more preferably less than 1 metre. However, as a real body, the cylinder according to the invention can naturally deviate from the ideal structure of a geometrically perfect cylinder. Preferably the real structure can be approximated to 5 vol. %, more preferably to 3 vol. % by means of a geometrically ideal cylinder. In the case of moulding without defined end, after random selection at least 4, preferably 4, pieces of the cylinder are separated and measured for the determination of the average volume. The length of the pieces here is at least 7 cm, preferably 7 cm, provided that the arithmetic mean of base area and top area is at least 7 cm². If the arithmetic mean of base area and top area is x cm², where x is <7, the length is at least x cm, preferably x cm. The determination of the volume is effected by methods familiar to those skilled in the art, such as for example the determination of the displaced volume of the cylinder concerned in a liquid. The term “dimensionally stable” is understood to mean that under typical stressing such as storage, transportation and insertion into appropriate devices, the cylinder does not disintegrate, that is crumble or break up.

Preferably the term “dimensionally stable” is understood to mean that the cylinders have a bending strength of at least 0.006 N/mm².

The determination of the bending strength is effected by means of a three-point measurement. In this, a test piece preferably in the form of a rectangular solid with a square base area (2 cm) edge length and a height of at least 9 cm is arranged centrally on two support rods arranged parallel 8 cm apart. If the cylinder to be tested does not have a rectangular shape, it can be brought into rectangular shape, for example by grinding, sawing, cutting, etc. In the middle of the test piece (4 cm from each of the support rods), pressure is applied from above by means of a loading rod and the force applied is recorded. Support rods and loading rod are cylindrical bodies with a circular base surface and a diameter of 5 mm. The support rods and the loading rod are mounted freely, in order to minimize frictional effects. As the measuring instrument, an Instron 5565 universal testing machine is preferably used at 22° C. and 45% relative atmospheric humidity. The measurement is effected by means of a compression rate of 2 mm per minute using a 1000 N load cell. In this, the data capture and evaluation can be effected by means of the Instron programme Bluehill Vers. 3.42 with recording of the travel path and the force measured in the process up to the breakage of the sample. The bending strength is obtained according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support, from the maximum of the curves. For this, the arithmetic mean of at least 5 samples, preferably 5 samples, is used. Individual defective samples are naturally discarded and not used in the calculation. For example, a lower bending strength can be caused by an air bubble enclosed in the bar. Preferably, the bending strength of individual samples is neglected if their bending strength deviates by at least 10% from the arithmetic mean of the remaining samples, with the most markedly deviating samples being discarded. In this, up to 10% of the samples, where the number of these 10% is rounded up to a whole number, are discarded. Instead of these discarded samples, replacement measurements are performed once.

In the sense of the invention, glass particles are understood to be in particular particles with silicon dioxide as the main component. An example of a glass to be particularly advantageously used is borosilicate glass.

The term mica particles is preferably understood to mean particles of mica, such as for example fluorophlogopite. Natural micas admittedly have cost advantages, however for use purposes for which a precise composition must be observed, for example in the food sector or the semiconductor industry, synthetic mica must be preferred.

An example of ceramic particles are particles of aluminium oxide ceramics.

Preferable further developments of the method according to the invention are for example to be found in aspects 2 to 28 and claims 2 to 12.

Further, the present invention relates to a particle-containing cylinder, wherein the cylinder has a volume of at least 5 cm³ and is dimensionally stable,

the content of particles lies in the range from 10 wt. % to 99.9 wt. %, based on the total weight of the cylinder,
the bending strength σ is at most 3.75 N/mm², where σ is calculated according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support,
the particles are selected from the group consisting of metal particles, glass particles, mica particles, ceramic particles and mixtures thereof,
the particles contained in the cylinder have a d₅₀ of at most 300 μm and the cylinder contains at least 0.01 wt. % of binder, based on the total weight of the particle-containing cylinder, where the binder is selected from the group consisting of inorganic binders, organic binders and mixtures thereof. Preferably the inorganic binders are selected from the group consisting of calcium sulphate, talc, calcium hydroxide, silicon oxide, aluminium oxide, calcium carbonate, calcium silicate hydrates, calcium aluminate hydrates and mixtures thereof. The organic binders are preferably selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, still more preferably from the group consisting of cellulose, cellulose derivatives, polysaccharides, gelatine, polyvinyls, polyacrylates, polyethylene oxides, polyethylene glycols, polyamides, epoxy resins, the salts of the aforesaid substances and mixtures thereof.

Preferred further developments of the cylinders according to the invention are to be found for example in aspects 30 to 50 and claim 14.

The present invention further relates to use of a cylinder according to the invention for creating a particle-containing aerosol.

Preferred further developments of the uses according to the invention are for example to be found in aspect 52.

Further, the present invention relates to an object which has been coated by means of an aerosol generated according to the invention.

The present invention relates to a method for the production of a particle-containing aerosol, wherein a particle-containing cylinder is comminuted. The comminution of the cylinder can be effected by methods familiar to those skilled in the art. For example, devices using a brush or an abrasive belt have proved effective. Appropriate devices using a brush are for example often used for converting a loose powder into aerosol form. Further delivery devices use rotating milling heads such as roughing mills or face mills. Further, abrasive discs or abrasive rollers with abrasive particles such as for example silicon carbide, tungsten carbide or diamond can be used. However, a particular advantage of the present invention is that particularly easily processable bars can be obtained, which can be used by means of simple delivery methods such as brush delivery without marked abrasion on the delivery device.

It has been found that the particles can be extremely well dispersed again by means of the method according to the invention. For example, measurements of the particle sizes showed only slightly higher average particle size of the aerosol particles after separation of the bar compared with the original particles. In further embodiments, the average particle size (D₅₀) of the aerosol is preferably at most 5 times, more preferably at most 3 times, still more preferably at most double that of the particles. The measurement of the average particle size of the particles contained in the bar and of the aerosol particles is preferably effected here by laser granulometry using a HELOS particle size analyser from the company Sympatec GmbH, Clausthal-Zellerfeld, Germany. In this, the dispersion of a dry powder can be effected with a disperser unit of the Rodos T4.1 type at a primary pressure of for example 4 bar. The assessment of the scattered light signals here is effected by the Fraunhofer method.

The aerosol according to the invention is preferably transferred directly into the desired application as an aerosol stream. Surprisingly, by means of the method according to the invention, an extremely uniform aerosol stream can be generated, which can particularly advantageously be used in coating processes such as non-thermal plasma spraying. It is presumed that coating processes which typically cause only very slight activation of the particles introduced benefit particularly strongly from the particularly homogeneous aerosol stream, as a result of which very homogenous and high-quality coatings are obtained. However, the aerosol produced according to the invention can be used for coating a great variety of materials using a great variety of coating processes. In this connection, coating processes which are selected from the group consisting of cold gas spraying, flame spraying, high velocity flame spraying, thermal plasma spraying and non-thermal plasma spraying have been found particularly advantageous. In particular, the method according to the invention has been found advantageous in combination with non-thermal plasma spraying.

Cold gas spraying is characterized in that a particulate material to be applied is not fused in the gas jet, but rather the particles are strongly accelerated and as a result of their kinetic energy form a coating on the surface of the substrate. In this, various gases known to those skilled in the art can be used as the carrier gas, such as for example nitrogen, helium, argon, air, krypton, neon, xenon, carbon dioxide, oxygen or mixtures thereof. In certain modifications it is particularly preferable that air, helium or mixtures thereof are used as the gas.

Through controlled expansion of the aforesaid gases in an appropriate nozzle, gas velocities of up to 3000 m/s are attained. The particles can thereby be accelerated to up to 2000 m/s. However, in certain modifications of cold gas spraying it is preferable that the particles for example attain velocities between 300 m/s and 1600 m/s, preferably between 1000 m/s and 1600 m/s, more preferably between 1250 m/s and 1600 m/s.

A disadvantage is for example the major noise generation which is caused by the high velocities of the gas streams used.

In flame spraying, a particulate material is for example converted into the liquid or plastic state by means of a flame and then applied as a coating onto a substrate. In this, for example a mixture of oxygen and a combustible gas such as acetylene or hydrogen is burnt. In certain modifications of flame spraying, part of the oxygen is used to convey the powdery coating material into the combustion flame. In common modifications of this method, the particles attain velocities of between 24 to 31 m/s.

Similarly to flame spraying, in high velocity flame spraying a particulate material for example is also converted into a liquid or plastic state by means of a flame. However, in comparison to the aforesaid method, the particles are significantly more highly accelerated. In specific examples of the aforesaid method, for example a velocity of the gas stream of 1220 to 1525 m/s with a velocity of the particles of ca. 550 to 795 m/s is mentioned. In further modifications of this method, however, gas velocities of over 2000 m/s are even attained. In general, in common modifications of the above method, it is preferable that the velocity of the flame lies between 1000 and 2500 m/s. Further, in common modifications it is preferable that the flame temperature lies between 2200° C. and 3000° C. The temperature of the flame is thus comparable to the temperature in flame spraying. This is achieved by combustion of the gases under a pressure of ca. 515 to 621 kPa followed by expansion of the combustion gases in a nozzle. In general, it is held that coatings created in this manner have a higher density, compared for example with coatings obtained by the flame spray method.

Detonation/explosive flame spraying can be regarded as a subtype of high velocity flame spraying. In this, a particulate material is strongly accelerated by repeated detonations of a gas mixture such as acetylene/oxygen, as a result of which for example particle velocities of ca. 730 m/s are attained. In this, the detonation frequency of the method for example lies between ca. 4 to 10 Hz. However, in modifications such as so-called high frequency gas detonation spraying, detonation frequencies around ca. 100 Hz are also selected.

The layers obtained should usually have particularly high hardness, strength and density, and good binding to the substrate surface. Disadvantages in the aforesaid method are the increased safety expenditure, and for example the major noise exposure because of the high gas velocities.

In thermal plasma spraying, for example a primary gas such as argon at a velocity of 40 l/min and a secondary gas such as hydrogen at a velocity of 2.5 l/min are passed through a direct current arc furnace, whereby a thermal plasma is generated. Next, for example 40 g/min of the powdery coating material is introduced by means of a carrier gas stream which is passed into the plasma flame at a velocity of 4 l/min. In common modifications of thermal plasma spraying, the delivery rate of the powdery coating material is between 5 g/min and 60 g/min, more preferably between 10 g/min and 40 g/min.

In certain modifications of the method, it is preferable to use argon, helium or mixtures thereof as the ionizable gas. Further, in certain modifications the overall gas stream is preferably 30 to 150 SLPM (standard litres per minute). The electric power used for the ionization of the gas stream excluding the thermal energy removed as a result of cooling can for example be selected between 5 and 100 kW, preferably between 40 and 80 kW. Plasma temperatures between 4000 K and a few 10000 K can thereby be attained.

In non-thermal plasma spraying, a non-thermal plasma is used for activation of the powdery coating material. The plasma used in this is for example generated with a barrier discharge or corona discharge with a frequency from 50 Hz to 1 MHz. In certain modifications of non-thermal plasma spraying, it is preferable to operate at a frequency from 10 kHz to 100 kHz. The temperature of the plasma here is preferably less than 3000 K, preferably less than 2500 K and still more preferably less than 2000 K. This minimizes the technical expenditure and keeps the energy input into the coating material to be applied as low as possible, which in turn enables gentle coating of the substrate. The order of magnitude of the temperature of the plasma flame is thus preferably comparable with that in flame spraying or in high velocity flame spraying. By specific selection of the parameters, non-thermal plasmas can also be generated, the core temperature whereof is below 1173 K or even below 773 K in the core region. The measurement of the temperature in the core region is effected here for example with an NiCr/Ni type thermocouple and a tip diameter of 3 mm at a distance of 10 mm from the nozzle exit in the core of the emergent plasma beam at ambient pressure. Such non-thermal plasmas are particularly suitable for coatings of very temperature-sensitive substrates.

Further, these methods enable the creation of coatings with sharp boundaries without the need to specifically mask regions. In this context, it has been found advantageous in particular to configure the exit aperture of the plasma flame in such a manner that the track widths of the coatings created lie between 0.2 mm and 10 mm. This enables a very precise, flexible, energy-efficient coating with best possible utilization of the coating material used. As the distance of the spray lance from the substrate, a distance of 1 mm is for example selected. This enables greatest possible flexibility of the coatings and at the same time ensures excellent quality coatings. The distance between spray lance and substrate usefully lies between 1 mm and 35 mm.

As the ionizable gas in the non-thermal plasma method, various gases and mixtures thereof known to those skilled in the art can be used. Examples of these are helium, argon, xenon, nitrogen, oxygen, hydrogen or air, preferably argon or air. A particularly preferable ionizable gas is air.

For example, to reduce the noise exposure it can also be preferable here that the velocity of the plasma stream lies below 200 m/s. As the flow velocity, for example a value between 0.01 m/s and 100 m/s, preferably between 0.2 m/s and 10 m/s can be selected. In particular, in certain embodiments it is for example preferable that the volume flow of the carrier gas lies between 10 and 25 l/min, more preferably between 15 and 19 l/min.

The cylinders according to the invention enable particularly uniform delivery of the particles and thereby the generation of a particularly homogeneous aerosol. In further embodiments, in the method according to the invention an aerosol stream is generated the fluctuation whereof lies below 20%, preferably below 10%, more preferably below 5%. Such uniform delivery can for example be maintained over a period of at least 10 mins, preferably at least 20 mins, more preferably at least 40 mins.

It has been found that the height of the cylinders according to the invention in further embodiments is advantageously at least double, preferably at least three times, more preferably at least 4 times the arithmetic mean of the longest axes along the base area and the top area. The “height” of the cylinder designates the distance between base area and top area. For example, the height of a cylinder according to the invention of circular base area and top area each with a diameter of 5 cm in each case is advantageously at least 10 cm, preferably at least 15 cm, more preferably at least 20 cm.

In further embodiments, it is preferable that the base area and top area of the particle-containing cylinder are essentially elliptical or circular, preferably circular. In particular, it is preferable here that the surface area of the base area and top area deviates from the surface area of an ideal geometrical ellipsoidal area or circular area up to a deviation of at most 10%, more preferably of at most 7%, still more preferably of at most 4%.

Further, in further embodiments it is preferable that the longitudinal axis stands essentially perpendicular to the base area and top area. Preferably, the deviation is less than 3°, more preferably less than 2°.

In particular, by means of the method according to the invention particularly homogeneous coatings can be produced even under very mild conditions. For example, under already very mild coating conditions using non-thermal plasma spraying, coatings can be obtained which are characterized by an extremely homogeneous thickness even with very thin layer thicknesses, see for example FIG. 3. Thus the differences between minima and maxima are preferably at most 5 μm, more preferably at most 3 μm. In further embodiments, the differences between minima and maxima are preferably at most 20%, more preferably at most 14%, still more preferably at most 9%, based on the overall thickness of the coating.

Further, the present invention relates to particle-containing cylinders, wherein the cylinder has a volume of at least 5 cm³ and is dimensionally stable,

the content of particles lies in the range from 10 wt. % to 99.9 wt. %, based on the total weight of the cylinder,
the bending strength σ is at most 3.75 N/mm², where σ is calculated according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support,
the particles are selected from the group consisting of metal particles, glass particles, mica particles, ceramic particles and mixtures thereof,
the particles contained in the cylinder have a d₅₀ of at most 300 μm and the cylinder contains at least 0.01 wt. % of binder, based on the total weight of the particle-containing cylinder, where the binder is selected from the group consisting of inorganic binders, organic binders and mixtures thereof. The inorganic binders are preferably selected from the group consisting of calcium sulphate, talc, calcium hydroxide, silicon oxide, aluminium oxide, calcium carbonate, calcium silicate hydrates, calcium aluminate hydrates and mixtures thereof. The organic binders are preferably are selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, the salts of the aforesaid substances and mixtures thereof. The determination of the particle content and binder content is performed by methods familiar to those skilled in the art such as AAS, EDX and RFA. The total weight of the cylinder is determined in the dry state. Preferably after at least 24 hrs, more preferably 24 hrs, storage under STPD conditions (0° C., 101 kPa and water vapour partial pressure=0 kPa). Unless otherwise stated, the other weight data of this invention are also measured under these conditions.

It was found that with cylinders with very low dimensional stability or with a very low bending strength the storage, transport and handling of the cylinder became drastically more difficult. In further embodiments, the cylinders preferably have a bending strength of at least 0.0075 N/mm², more preferably at least 0.0105 N/mm², still more preferably at least 0.012 N/mm², still more preferably at least 0.015 N/mm².

Further, it was found that through the use of cylinders with low bending strength, the delivery properties could be further simplified. In further embodiments, the bending strength is therefore preferably at most 2.1 N/mm², more preferably at most 1.2 N/mm², still more preferably at most 0.675 N/mm².

In particular, in further embodiments it is preferable that the bending strength lies in the range from 0.0075 to 3.75 N/mm², more preferably in the range from 0.0105 to 2.1 N/mm², still more preferably in the range from 0.012 to 1.2 N/mm² and still more preferably in the range from 0.015 to 0.675 N/mm².

Here the bending strength can be specifically adjusted by those skilled in the art for example via the selection of the binder, the content thereof, the content of any fillers contained, etc. An increase in the bending strength can for example be achieved by using a binder with high strength, increasing the binder content, the pressure in the compression of suitable cylinders, etc. A decrease can for example be achieved by selection of a binder with low binding action, by lowering the binder content, increasing the solvent content, addition of a filler, etc. Further, it has been observed that typically for obtention of an identical bending strength, more binder must be used the more the particles deviate from the spherical ideal shape and the lower the density of the material of the particles. Further, for creation of homogenous cylinders, it has been found advantageous if for example in production methods such as slurry casting, the content of solvent should be kept as low as possible. A suitable suspension should be flowable, but contain as little solvent as possible. Further, various additives can be used in order to produce the cylinders according to the invention. For example, rheology-modifying additives can be used, which impart thixotropic behaviour to the suspensions concerned. Further, wetting agents can be used in order for example to facilitate incorporation of the particles and/or of the binder into the desired solvent. Examples of these are surfactants or organic solvents.

The particles can also be coated with binder before the production of the bar. This has the advantage that a particularly homogeneous distribution of the binder can be achieved even at low binder contents without vigorous mixing steps or solvents. Such a coating, for example consisting of a monomer, is thereby polymerized optionally with further binders, in order to bring about the cohesion of the bar. However, for example the coated particle material can also be transferred into a mould without further binder and thermally hardened. According to the present invention, coatings of the particles which have a composition at least comparable to the binder, such as for example a polyacrylate coating with a polyacrylate binder or a silicon oxide-containing coating with a silicon oxide binder are counted in the binder content. Preferably however, only coatings of the particles which have also formed a covalent bond to the binder are counted in the binder content.

As rheology-modifying additives, for example polymeric materials such as polyacryl-amides, polyacrylic acids, carboxymethylcelluloses, hydroxypropylmethylcelluloses, methylcelluloses, alginates, polyethylene glycols, polyvinyl alcohols, polyvinylpyrrolidones, polyurethanes and polysaccharides and inorganic additives such as silicon dioxide and organoclays can be used. Thus for example BYK-410, BYK-411, BYK-415, BYK-420, BYK-425, BYK-428, BYK-430 and BYK-431 are obtainable from the company BYK-Chemie as polymeric rheology-modifying additives. One example of organoclays are the bentonites. As a rheology-modifying additive from the silicon dioxides group, for example pyrogenic silicic acid can be used.

The particles used in the cylinders according to the invention preferably have a d₅₀ in a range from 1 μm to 300 μm, preferably in a range from 1.5 μm to 230 μm, more preferably in a range from 2 μm to 180 μm, still more preferably in a range from 2.5 μm to 150 μm. Under a wide spectrum of delivery conditions and delivery volumes these displayed good and homogeneous aerosol formation and good results in the common coating processes.

To achieve the greatest possible particle contents in the particle-containing cylinders it has been found advantageous to use non-flaky particles. Surprisingly, it has been found that high pigmentation levels can thereby be achieved very simply, without it being necessary for example to use additives in the processing. Here, the content of particles preferably lies in a range from 50 wt. % to 99.9 wt. %, more preferably in a range from 60 wt. % to 98 wt. %, still more preferably in a range from 70 wt. % to 97 wt. %, each based on the total weight of the cylinder.

If the aerosol stream according to the invention is to be used in an application in which for example a small quantity of energy is to be introduced, such as non-thermal plasma spraying, it has been found difficult to create a homogeneous coating with the non-flaky coating material under particularly mild coating conditions. In further embodiments, it is preferable that the particles of the cylinders according to the invention are flaky particles, where the content of flaky particles in the particle-containing cylinder lies in a range from 30 wt. % to 75 wt. %, preferably in a range from 40 wt. % to 70 wt. %, more preferably in a range from 50 wt. % to 65 wt. %, each based on the total weight of the cylinder. These cylinders yielded good results as regards the delivery properties of the particles in subsequent applications such as non-thermal plasma spraying. The good results even under very mild coating conditions are attributed to the fact that the markedly greater surface area of these particles enables stronger activation. However, with too high a content of flaky particles, it was found difficult to ensure adequate stability of the cylinders. In the sense of the present invention, the term “flaky” is understood to mean that relevant particles have an aspect ratio of at least 10. In the sense of the present invention, particles with an aspect ratio of less than 10 are described as “non-flaky”.

In the sense of the present invention, the term “aspect ratio” designates the ratio of the average particle diameter (d₅₀) to the average particle thickness (h₅₀). The term “d₅₀” or also “d₅₀ value” designates the value at which 50% of the particles in the cumulative frequency distribution have a diameter which is equal to or less than this value. The measurements are preferably made with the particle size analyser HELOS from the company Sympatec GmbH, Clausthal-Zellerfeld, Germany. Here, the dispersion of a dry powder can be effected with a disperser unit of the Rodos T4.1 type at a primary pressure of for example 4 bar. Alternatively, the size distribution curve of the particles can be measured for example with an instrument from the company Quantachrome (instrument: Cilas 1064) according to the manufacturer's instructions. For this, 1.5 g of the powdery coating material are dispersed in ca. 100 ml ethanol, processed for 300 seconds in the ultrasound bath (instrument: Sonorex IK 52, Bandelin Co.) and then introduced by means of a Pasteur pipette into the sample preparation cell of the measuring instrument and measured several times. The resultant mean values are formed from the individual measurement results. Also, the scattered light signals are evaluated by the Fraunhofer method.

The thickness of the particles can for example be determined as follows by SEM. The flaky particles according to the invention are firstly washed with acetone and then desiccated. A resin usual in electron microscopy, for example TEMPFIX (Gerhard Neubauer Chemikalien, D-48031 Munster, Germany), is placed on a sample plate and heated to softening on a hotplate. Next, the sample plate is removed from the hotplate and the particles are scattered onto the softened resin. Due to the cooling, the resin again becomes solid and, due to the interplay between adhesion and gravity, the scattered particles can be prepared standing almost vertical and fixed on the sample plate. As a result, the particles can readily be measured from the side in the electron microscope. In the measurement of the thickness, the azimuthal angle α of the particle to a plane normal to the surface is estimated and taken into account in the thickness evaluation according to the formula

h_{eff}=hₘₑₐₛ/cos α

The cumulative distribution curve is generated from the h_{eff} values on the basis of the relative frequencies. Ca. 100 particles preferably 100 particles, are counted.

If the aforesaid procedure is not usable, the thicknesses of the particles can for example also be counted on the basis of cross-sections of painted samples. However, this method should only be used with very good plane parallel orientation of the particles. Otherwise, the particles in the cross-section may be oriented with an azimuthal angle of inclination, which is however not discernible to the observer. This systematically results in the measurement of higher thicknesses.

In further embodiments the quantity of the particles in the cylinder as a function of the quantity of the flaky particles, with x wt. % flaky particles, based on the total weight of the particles, lies in the range from (50 wt. %−(0.2×x) wt. %) to (99.9 wt. %−(0.249×x) wt. %), preferably in the range from (60 wt. %−(0.2×x) wt. %) to (98 wt. %−(0.28×x) wt. %), more preferably in the range from (70 wt. %−(0.2×x) wt. %) to (97 wt. %−(0.32×x) wt. %), based on the total weight of the cylinder.

In further embodiments, the cylinder according to the invention contains fillers, which are preferably selected from the group consisting of layer silicates, clay minerals, metal oxides, silica gel, glass beads and mixtures thereof.

Further, in further embodiments it is preferable that the cylinders according to the invention contain boron nitride. Through the addition of boron nitride, for example increased abrasion resistance and thermal conductivity could be achieved. Preferably the quantity of the boron nitride lies in a range from 0.1 wt. % to 50 wt. %, more preferably in a range from 0.1 wt. % to 20 wt. %, still more preferably in a range from 0.1 wt. % to 15 wt. %, each based on the total weight of the cylinder.

In further embodiments, it preferable that the total quantity of particles and binders in the particle-containing cylinder is at least 90 wt. %, preferably at least 95 wt. %, more preferably at least 99.9 wt. %, each based on the total weight of the cylinder. In particular, it has been found advantageous to decrease unreactive fillers contained since improved coating formation, for example decreased overspray, could be achieved thereby.

Further, in further embodiments it is preferable that the particles of the particle-containing cylinder are at least 90 wt. %, preferably at least 95 wt. %, more preferably at least 99.9 wt. % selected from either metal particles or glass particles or mica particles or ceramic particles, based on the total weight of the particles. The use of metal particles and glass particles, in particular metal particles, has been found particularly advantageous.

The cylinders according to the invention can be used in the form of individual cylinders or as theoretically endless cylinders. The latter are for example obtainable by direct extrusion of the cylinder material, with the extruded cylinder being fed directly into the delivery device. In this, binders which provide rapid solidification of the cylinder material after the mould release step, such as for example microcrystalline cellulose, are preferable. The use of such a combination of an extrusion step with the delivery step enables almost unlimited, continuous delivery.

On the other hand, use of individual cylinders enables simpler equipment design and simpler switching between different bar types. Here, to obtain simplified delivery, it was typically found advantageous if the particle-containing cylinder according to the invention has a volume of at least 8 cm³, preferably of at least 11 cm³, more preferably of at least 19 cm³, still more preferably of at least 30 cm³.

In further embodiments, the quantity of the binder used lies in a range from 0.05 wt. % to 70 wt. %, preferably in a range from 0.07 wt. % to 60 wt. %, more preferably in a range from 0.1 wt. % to 45 wt. %. Further, in further embodiments the quantity of inorganic binder preferably lies in a range from 1.5 wt. % to 70 wt. % and the quantity of organic binder in a range from 0.05 wt. % to 50 wt. %, more preferably the quantity of inorganic binder in a range from 1.9 wt. % to 60 wt. % and the quantity of organic binder in a range from 0.07 wt. % to 35 wt. %, still more preferably the quantity of inorganic binder in a range from 2.2 wt. % to 45 wt. % and the quantity of organic binder in a range from 0.1 wt. % to 25 wt. %.

In further embodiments, it is preferable that at least one binder of the particle-containing cylinder is selected from the inorganic binders. These binders are found advantageous for the preparation of particularly stable cylinders, which for example provide high storability and stability under UV radiation. Examples of such inorganic binders are calcium sulphate, talc, calcium hydroxide, silicon oxide, aluminium oxide, calcium carbonate, calcium silicate hydrates, calcium aluminate hydrates and mixtures thereof, where the aforesaid substances may contain water, in particular in the form of water of crystallization. Here the particle-containing cylinder preferably contains at least 1.5 wt. %, more preferably at least 1.9 wt. %, still more preferably at least 2.2 wt. %, of inorganic binder.

Calcium sulphate and hydrates thereof are for example commercially available under the name gypsum. For the applications according to the invention, high quality modifications of gypsum such as dental plaster and plaster of Paris, in particular dental plaster, have been found advantageous. It has been found that low quality varieties of gypsum such as building plaster yielded markedly worse results. It is presumed that controlled binding is necessary to obtain a homogeneous structure of the cylinders. Building plasters on the other hand, owing to the price-driven mass production, appear to have a less uniform composition, as a result of which uniform bonding cannot be ensured. It is presumed that owing to their different properties, the different modifications of gypsum which are obtained by variation of the temperature and ambient conditions such as pressure, do not enable the production of high-quality bars according to the invention.

Unless otherwise specified, in the present invention it is particularly preferable that “essentially” means at least 95%, preferably at least 99%. If it refers to a material-related feature, such as for example the quantity of a material component, then wt. % is meant thereby.

Calcium sulphate, talc, calcium carbonate, silicon oxide, mixtures of calcium silicate hydrates and calcium aluminate hydrates and mixtures of calcium hydroxide and calcium carbonate, in particular calcium sulphate and silicon oxide have been found advantageous for most applications, where the aforesaid substances may contain water, in particular in the form of water of crystallization. A particularly preferable inorganic binder is calcium sulphate, where the calcium sulphate may contain water, in particular in the form of water of crystallization.

In the sense of the present invention, the term “calcium sulphate” is also understood to mean the hydrates of calcium sulphate. This binder has been found particularly advantageous since under the typical conditions of subsequent coating processes it can be applied without noticeable impairment of the resulting coatings and owing to its low reactivity it is suitable for formulation with a broad range of particles according to the invention. Typically, calcium sulphate has 2 molecules of water bound as water of crystallization per calcium sulphate molecule.

Further, in further embodiments silicon oxide has been found to be an advantageous binder, where the term “silicon oxide” in the sense of the present invention also includes the hydrates of silicon oxide. Preferably the silicon dioxide of the present invention is essentially silicon dioxide. In the use of silicon oxide, for example the stability of cylinders thereby obtained can be specified in a broad range by process technology details such as the hardening conditions and variation of the educts. For example, simply with hardening at room temperature, different results can be achieved by use of a defined gas stream such as air or CO₂, the duration of the gas stream, and the volume of the gas used. Further, with the use of waterglass, the hardness of the cylinder obtained can be varied for example by addition of amorphous silicon. Thus the product desired by the client can be specifically produced from a simple and inexpensive basic system.

Further, in further embodiments it is preferable that at least one binder of the particle-containing cylinder is an organic binder which is selected from the group consisting of cellulose; cellulose derivatives such as methylcellulose, ethylcellulose, microcrystalline cellulose, hydroxyethylcellulose, hydroxypropylcellulose, hydroxypropylmethylcellulose, carboxyethylcellulose, cellulose acetate butyrate and carboxymethylcellulose; polysaccharides such as alginic acid, alginic acid derivatives, starch, starch derivatives, xanthan, dextrins, dextrans, guar gum, carob bean gum, carrageen and pullulan; gelatine; polyvinyls such as polyvinyl alcohols, polyvinylpyrrolidones and polyvinylbutyrals; polyacrylates such as polyacrylic acids and polyacrylate esters; polyethylene oxides; polyethylene glycols; polyamides; epoxy resins; the salts of the aforesaid substances and mixtures thereof. These binders have for example the advantage that they can at least partially, preferably completely, burn in the flame of a coating process and the gas produced is not incorporated into the coating and can thus easily be separated. Preferable salts are alkali metal and alkaline earth metal salts such as sodium salts, potassium salts, ammonium salts and calcium salts. Further it is preferable that the cellulose derivatives are water-soluble. Polyacrylic acids are for example obtainable under the name CARBOPOL, such as CARBOPOL 941 and CARBOPOL 934. Here, the particle-containing cylinder preferably contains at least 0.05 wt. %, more preferably at least 0.07 wt. %, still more preferably at least 0.1 wt. %, of organic binder. In further embodiments it is preferable that the cellulose derivatives are selected from the group consisting of methylcellulose, ethylcellulose, microcrystalline cellulose, hydroxyethylcellulose, hydroxypropylcellulose, hydroxypropylmethylcellulose, carboxyethylcellulose and carboxymethylcellulose.

In further embodiments, the organic binder is preferably selected from the group consisting of cellulose; cellulose derivatives such as methylcellulose, ethylcellulose, microcrystalline cellulose, hydroxyethylcellulose, hydroxypropylcellulose, hydroxypropylmethylcellulose, carboxyethylcellulose and carboxymethylcellulose; polysaccharides such as alginic acid, alginic acid derivatives, starch, starch derivatives, xanthan, dextrins, dextrans, guar gum, carob bean gum, carrageen and pullulan; gelatine; polyvinyls such as polyvinyl alcohols, polyvinylpyrrolidones and polyvinylbutyrals; polyacrylates such as polyacrylic acids and polyacrylate esters; polyethylene oxides; polyethylene glycols; polyamides; the salts of the aforesaid substances and mixtures thereof, and more preferably are selected from the group consisting of cellulose; cellulose derivatives such as methylcellulose, ethylcellulose, microcrystalline cellulose, hydroxyethylcellulose, hydroxypropylcellulose, hydroxypropylmethylcellulose, carboxyethylcellulose and carboxymethylcellulose; polysaccharides such as alginic acid, alginic acid derivatives, starch, starch derivatives, xanthan, dextrins, dextrans, guar gum, carob bean gum, carrageen and pullulan; the salts of the aforesaid substances and mixtures thereof. Particularly preferable polyvinyls are polyvinyl alcohols and polyvinylpyrrolidones.

Examples of further organic binders, which in further embodiments are in particular to be understood as an extension of the aforesaid groups are urea-formaldehyde copolymers, melamine-formaldehyde copolymers, acrylate ester-acrylonitrile copolymers, polyesters of polycarboxylic acids and polyhydric alcohols, acrylate ester-acrylonitrile copolymers, acrylate esters-styrene copolymers, acrylamide copolymers and butadiene-styrene copolymers. However, the aforesaid group also represents an independent group, very advantageous for certain embodiments. Examples of these are Styrofan D 780 S, Acronal 12 DE, Acronal 32 D, Acronal S 888 S, Acronal LN 838 S, Acrodur DS 3530, Acronal LN 579 S, Saduren 163 and Urecoll 135 and Acrodur DS 3515.

According to the invention, the term “polymers” also includes oligomers. Preferably the polymers according to the invention such as for example cellulose derivatives, polysaccharides, polyvinyls, polyacrylates and polyethylene glycols have at least 10 monomer units, more preferably at least 20 monomer units, still more preferably at least 60 monomer units.

In particular, in further embodiments it is preferable that the binder is selected from the group consisting of calcium sulphate, talc, calcium carbonate, silicon oxide, mixtures of calcium silicate hydrates and calcium aluminate hydrates, mixtures of calcium hydroxide and calcium carbonate, cellulose, cellulose derivatives, polysaccharides, polyvinyls, polyacrylates, polyethylene oxides, polyethylene glycols, polyamides, the salts of the aforesaid substances and mixtures thereof, preferably from the group consisting of calcium sulphate, silicon oxide, cellulose, cellulose derivatives, polysaccharides, polyvinyls, the salts of the aforesaid substances and mixtures thereof, more preferably from the group consisting of calcium sulphate, silicon oxide, cellulose derivatives, polysaccharides, the salts of the aforesaid substances and mixtures thereof. The aforesaid binders calcium sulphate and silicon oxide may contain water in bound form, in particular as water of crystallization. Calcium sulphate and cellulose derivatives have been found to be particularly advantageous binders according to the invention.

In further embodiments, the particles of the particle-containing cylinder are at least 75 wt. %, preferably at least 87 wt. %, more preferably at least 98 wt. % metal particles, based on the total weight of the particles. In the sense of the present invention, the term “metal particles” is understood to mean that the particles consist of at least 80 wt. %, more preferably at least 90 wt. % elemental metal, metal mixtures or metal alloys.

In further embodiments the metal of the metal particles is at least 90 wt. % selected from the group consisting of aluminium, copper, tin, zinc, iron, silver, titanium, nickel, gold, platinum, magnesium, tungsten, molybdenum, vanadium, mixtures thereof and alloys thereof.

In further embodiments, the metal of the metal particles comprises at most 5 wt. %, more preferably at most 2 wt. %, more preferably at most 1 wt. % of metals which are selected from the group consisting of silver, palladium, platinum, gold, mixtures thereof and alloys thereof.

In further embodiments, the metal particles are preferably selected from uncoated metal particles and coated metal particles, where the quantity of the coating of the coated metal pigments is at most 15 wt. %, preferably at most 12 wt. %, more preferably at most 10 wt. % based on the total weight of the coated metal pigments.

The production of the cylinders according to the invention can for example be effected by producing a paste containing particles, gypsum (calcium sulphate) and water, filling the paste into a mould and hardening the paste. To facilitate the processing, a disproportionate quantity of water can also be used, which can subsequently be removed again by drying procedures. The drying can for example also be accelerated by use of a drying cabinet. Here, for the production of the cylinders using inorganic binders, reactive moulds such as calcium sulphate hemihydrate are preferably used. Further, for example mixtures of particles with organic binders such as polysaccharides, cellulose and cellulose derivatives can be produced and solidified by compression. In addition, organic binders can also be converted into paste form by means of a solvent such as water or an organic solvent and introduced into the desired mould. The cylinders according to the invention can then be obtained by drying the pastes.

On the other hand, for example cylinders which are produced by in-situ powder pressing processes and which are then used in a delivery method exhibit a very inhomogeneous composition, in particular with density gradients, as a result of which generation of a uniform aerosol stream becomes difficult to impossible. The cylinders according to the invention have a homogeneous composition in particular as regards the distribution of the particles contained therein. Thereby, uniform and reproducible delivery of the particles contained is enabled, while at the same time the delivered particles can be varied in a great variety of ways, without necessitating specific adaptation of the delivery parameters. The particularly homogeneous structure of the cylinders according to the invention can for example be demonstrated by means of the average density. For this, at least 3, preferably three, discs are cut out of the bar perpendicular to the longitudinal axis, with the thickness of the discs being at least 1 cm, preferably 1 cm. Next, the discs are cut into three, preferably approximately equal-sized, pieces and their average density determined. The determination of the average density is effected for example by means of a helium pycnometer of the Multipycnometer type (Quantachrome Co.). Preferably, the deviation of the average density of the samples is at most 10%, more preferably at most 7%, still more preferably at most 3%, based on the arithmetic mean of the samples.

Further, the present invention relates to the use of a particle-containing cylinder according to the invention for creating a particle-containing aerosol. Preferably one of the aforesaid specific forms of the cylinder is used.

Further, the present invention relates to a coated object, wherein the coating was effected using an aerosol which was generated by means of a method according to one of claims 1 to 12 or one of aspects 1 to 28 and/or using at least one cylinder according to one of claims 13 to 14 or one of aspects 29 to 50.

According to an aspect 1, the present invention preferably relates to a method for the production of a particle-containing aerosol, wherein a particle-containing cylinder is comminuted, where the cylinder has a volume of at least 5 cm³ and is dimensionally stable, the bending strength σ is at most 3.75 N/mm², more preferably at most 2.1 N/mm², still more preferably at most 1.2 N/mm², still more preferably at most 0.675 N/mm², where 6 is calculated according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support,
the content of particles lies in the range from 10 wt. % to 99.9 wt. %, based on the total weight of the cylinder,
the particles are selected from the group consisting of metal particles, glass particles, mica particles, ceramic particles and mixtures thereof,
the particles contained in the cylinder have a d₅₀ of at most 300 μm and
the cylinder contains at least 0.01 wt. % of binder, based on the total weight of the particle-containing cylinder, where the binder is selected from the group consisting of inorganic binders, organic binders and mixtures thereof.

According to an aspect 2, the present invention preferably relates to a method according to aspect 1, wherein the inorganic binders are selected from calcium sulphate, talc, calcium hydroxide, silicon oxide, aluminium oxide, calcium carbonate, calcium silicate hydrates, calcium aluminate hydrates and mixtures thereof.

According to an aspect 3, the present invention preferably relates to a method according to one of aspects 1 to 2, wherein the organic binders are selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, still more preferably from the group consisting of cellulose, cellulose derivatives, polysaccharides, gelatine, polyvinyls, polyacrylates, polyethylene oxides, polyethylene glycols, polyamides, epoxy resins, the salts of the aforesaid substances and mixtures thereof.

According to an aspect 4, the present invention preferably relates to a method according to one of aspects 1 to 3, wherein the cylinder has a bending strength of at least 0.0075 N/mm², more preferably at least 0.0105 N/mm², still more preferably at least 0.012 N/mm², still more preferably at least 0.015 N/mm².

According to an aspect 5, the present invention preferably relates to a method according to one of aspects 1 to 4, wherein the particle-containing aerosol is conveyed further as a continuous aerosol stream.

According to an aspect 6, the present invention preferably relates to a method according to one of aspects 1 to 5, wherein the particle-containing aerosol is used in a coating process which is selected from the group consisting of cold gas spraying, flame spraying, high velocity flame spraying, thermal plasma spraying and non-thermal plasma spraying, preferably are selected from the group consisting of thermal plasma spraying and non-thermal plasma spraying. In particular it is preferable that the coating process is non-thermal plasma spraying.

According to an aspect 7, the present invention preferably relates to a method according to one of aspects 1 to 6, wherein the comminution of the particle-containing cylinder is effected by means of a brush or an abrasive belt.

According to an aspect 8, the present invention preferably relates to a method according to one of aspects 1 to 7, wherein the height of the particle-containing cylinder is at least double, preferably at least 3 times, more preferably at least 4 times the arithmetic mean of the longest axes along the base area and the top area.

According to an aspect 9, the present invention preferably relates to a method according to one of aspects 1 to 8, wherein the cylinder contains at least 1.5 wt. % of inorganic binder or at least 0.01 wt. % of organic binder.

According to an aspect 10, the present invention preferably relates to a method according to one of aspects 1 to 9, wherein the content of non-flaky particles in the particle-containing cylinder lies in a range from 50 wt. % to 99.9 wt. %, preferably in a range from 60 wt. % to 98 wt. %, more preferably in a range from 70 wt. % to 97 wt. %, each based on the total weight of the cylinder.

According to an aspect 11, the present invention preferably relates to a method according to one of aspects 1 to 10, wherein the particles contained in the cylinder have a d₅₀ in a range from 1 μm to 300 μm, preferably in a range from 1.5 μm to 230 μm, preferably in a range from 2 μm to 180 μm, more preferably in a range from 2.5 μm to 150 μm.

According to an aspect 12, the present invention preferably relates to a method according to one of aspects 1 to 9 or according to aspect 11, wherein the content of flaky particles in the particle-containing cylinder lies in a range from 30 wt. % to 75 wt. %, preferably in a range from 40 wt. % to 70 wt. %, more preferably in a range from 50 wt. % to 65 wt. %, each based on the total weight of the cylinder.

According to an aspect 13, the present invention preferably relates to a method according to one of aspects 1 to 12, wherein the quantity of the particles in the cylinder as a function of the quantity of the flaky particles, with x wt. % flaky particles, based on the total weight of the particles, lies in the range from (50 wt. %−(0.2×x) wt. %) to (99.9 wt. %−(0.249×x) wt. %), based on the total weight of the cylinder. Preferably, the quantity of the particles lies in the range from (60 wt. %−(0.2×x) wt. %) to (98 wt. %−(0.28×x) wt. %), more preferably in the range from (70 wt. %−(0.2×x) wt. %) to (97 wt. %−(0.32×x) wt. %), based on the total weight of the cylinder.

According to an aspect 14, the present invention preferably relates to a method according to one of aspects 1 to 13, wherein the total quantity of particles and binders in the particle-containing cylinder is at least 90 wt. %, preferably at least 95 wt. %, more preferably at least 99.9 wt. %, based on the total weight of the cylinder.

According to an aspect 15, the present invention preferably relates to a method according to one of aspects 1 to 14, wherein the particles of the particle-containing cylinder are at least 90 wt. %, preferably at least 95 wt. %, more preferably at least 99.9 wt. % selected from either metal particles or glass particles or mica particles or ceramic particles, based on the total weight of the particles. Preferably the particles of the particle-containing cylinder are at least 90 wt. %, preferably at least 95 wt. %, more preferably at least 99.9 wt. % selected from either metal particles or glass particles, more preferably metal particles, based on the total weight of the particles.

According to an aspect 16, the present invention preferably relates to a method according to one of aspects 1 to 15, wherein the particle-containing cylinder has a volume of at least 8 cm³, preferably of at least 11 cm³, more preferably of at least 19 cm³, still more preferably of at least 30 cm³.

According to an aspect 17, the present invention preferably relates to a method according to one of aspects 1 to 16, wherein the quantity of the binder in the particle-containing cylinder lies in a range from 0.05 wt. % to 70 wt. %, preferably in a range from 0.07 wt. % to 60 wt. %, more preferably in a range from 0.1 wt. % to 45 wt. %.

According to an aspect 18, the present invention preferably relates to a method according to one of aspects 1 to 17, wherein the particle-containing cylinder contains at least 1.5 wt. %, preferably at least 1.9 wt. %, more preferably at least 2.2 wt. %, of inorganic binder.

According to an aspect 19, the present invention preferably relates to a method according to one of aspects 1 to 18, wherein the inorganic binder is selected from the group consisting of calcium sulphate and silicon oxide.

According to an aspect 20, the present invention preferably relates to a method according to one of aspects 1 to 19, wherein the particle-containing cylinder contains at least 0.05 wt. %, preferably at least 0.07 wt. %, more preferably at least 0.1 wt. %, of organic binder.

According to an aspect 21, the present invention preferably relates to a method according to one of aspects 1 to 20, wherein the organic binder is selected from the group consisting of cellulose derivatives and polysaccharides. Preferably, the organic binder is selected from the group consisting of starch and cellulose derivatives. Examples of the cellulose derivatives are methylcellulose and ethylcellulose.

According to an aspect 22, the present invention preferably relates to a method according to one of aspects 1 to 21, wherein at least one binder of the particle-containing cylinder is selected from the group consisting of calcium sulphate, talc, calcium carbonate, silicon oxide, mixtures of calcium silicate hydrates and calcium aluminate hydrates, mixtures of calcium hydroxide and calcium carbonate, cellulose, cellulose derivatives, polysaccharides, gelatine, polyvinyls, polyacrylates, polyethylene oxides, polyethylene glycols, polyamides, the salts of the aforesaid substances and mixtures thereof, preferably from the group consisting of calcium sulphate, silicon oxide, cellulose, cellulose derivatives, polysaccharides, polyvinyls, the salts of the aforesaid substances and mixtures thereof, more preferably from the group consisting of calcium sulphate, silicon oxide, cellulose derivatives, polysaccharides, the salts of the aforesaid substances and mixtures thereof. In particular it is preferable that the binder is selected from the group consisting of calcium sulphate and cellulose derivatives.

According to an aspect 23, the present invention preferably relates to a method according to one of aspects 1 to 22, wherein the particles of the particle-containing cylinder are at least 75 wt. %, preferably at least 87 wt. %, more preferably at least 98 wt. %, metal particles, based on the total weight of the particles.

According to an aspect 24, the present invention preferably relates to a method according to one of aspects 1 to 23, wherein the metal of the metal particles is at least 90 wt. % selected from the group consisting of aluminium, copper, tin, zinc, iron, silver, titanium, nickel, gold, platinum, magnesium, tungsten, molybdenum, vanadium, mixtures thereof and alloys thereof.

According to an aspect 25, the present invention preferably relates to a method according to one of aspects 1 to 24, wherein the metal of the metal particles is at most 5 wt. %, more preferably at most 2 wt. %, more preferably at most 1 wt. %, selected from the group consisting of silver, palladium, platinum, gold, mixtures thereof and alloys thereof.

According to an aspect 26, the present invention preferably relates to a method according to one of aspects 1 to 25, wherein the metal particles are selected from uncoated metal particles and coated metal particles, wherein the quantity of the coating is on average at most 15 wt. %, preferably at most 12 wt. %, more preferably at most 10 wt. %, based on the total weight of the coated metal pigments.

According to an aspect 27, the present invention preferably relates to a method for coating a substrate, wherein it comprises the following steps

a) production of a particle-containing aerosol according to one of aspects 1 to 26,
b) deposition of the particles on a substrate by a coating process which is selected from the group consisting of cold gas spraying, flame spraying, high velocity flame spraying, thermal plasma spraying and non-thermal plasma spraying. Preferably, the coating process according to step b) is non-thermal plasma spraying.

According to an aspect 28, the present invention preferably relates to a method according to aspect 27, wherein the particle-containing aerosol from step a) is fed into the coating process according to step b) as a continuous aerosol stream.

According to an aspect 29, the present invention preferably relates to a particle-containing cylinder, wherein the cylinder has a volume of at least 5 cm³ and is dimensionally stable,

the content of particles lies in the range from 10 wt. % to 99.9 wt. %, based on the total weight of the cylinder,
the bending strength σ is at most 3.75 N/mm², more preferably at most 2.1 N/mm², still more preferably at most 1.2 N/mm², still more preferably at most 0.675 N/mm², where σ is calculated according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support,
the particles are selected from the group consisting of metal particles, glass particles, mica particles, ceramic particles and mixtures thereof,
the particles contained in the cylinder have a d₅₀ of at most 300 μm and
the cylinder contains at least 0.01 wt. % of binder, based on the total weight of the particle-containing cylinder, where the binder is selected from the group consisting of inorganic binders, organic binders and mixtures thereof

According to an aspect 30, the present invention preferably relates to a particle-containing cylinder according to aspect 29, wherein the inorganic binders are selected from calcium sulphate, talc, calcium hydroxide, silicon oxide, aluminium oxide, calcium carbonate, calcium silicate hydrates, calcium aluminate hydrates and mixtures thereof.

According to an aspect 31, the present invention preferably relates to a particle-containing cylinder according to one of aspects 29 to 30, wherein the organic binders are selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, still more preferably from the group consisting of cellulose, cellulose derivatives, polysaccharides, gelatine, polyvinyls, polyacrylates, polyethylene oxides, polyethylene glycols, polyamides, epoxy resins, the salts of the aforesaid substances and mixtures thereof.

According to an aspect 32, the present invention preferably relates to a particle-containing cylinder according to one of aspects 29 to 31, wherein the cylinder has a bending strength of at least 0.0075 N/mm², more preferably, at least 0.0105 N/mm², still more preferably at least 0.012 N/mm², still more preferably at least 0.015 N/mm².

According to an aspect 33, the present invention preferably relates to a particle-containing cylinder according to one of aspects 29 to 32, wherein the height of the particle-containing cylinder is at least double, preferably at least 3 times, more preferably at least 4 times, the arithmetic mean of the longest axes along the base area and the top area.

According to an aspect 34, the present invention preferably relates to a particle-containing cylinder according to one of aspects 29 to 33, wherein the content of non-flaky particles in the particle-containing cylinder lies in a range from 50 wt. % to 99.9 wt. %, preferably in a range from 60 wt. % to 98 wt. %, more preferably in a range from 70 wt. % to 97 wt. %, each based on the total weight of the cylinder.

According to an aspect 35, the present invention preferably relates to a particle-containing cylinder according to one of aspects 29 to 34, wherein the particles contained in the cylinder have a d₅₀ in a range from 1 μm to 300 μm, preferably in a range from 1.5 μm to 230 μm, preferably in a range from 2 μm to 180 μm, more preferably in a range from 2.5 μm to 150 μm.

According to an aspect 36, the present invention preferably relates to a particle-containing cylinder according to one of aspects 29 to 35, wherein the content of flaky metal particles in the particle-containing cylinder lies in a range from 30 wt. % to 75 wt. %, preferably in a range from 40 wt. % to 70 wt. %, more preferably in a range from 50 wt. % to 65 wt. %, each based on the total weight of the cylinder.

According to an aspect 37, the present invention preferably relates to a particle-containing cylinder according to one of aspects 29 to 36, wherein the quantity of the particles in the cylinder as a function of the quantity of the flaky particles, with x wt. % flaky particles, based on the total weight of the particles, is in the range from (50 wt. %−(0.2×x) wt. %) to (99.9 wt. %−(0.249×x) wt. %), based on the total weight of the cylinder. Preferably the quantity of the particles lies in the range from (60 wt. %−(0.2×x) wt. %) to (98 wt. %−(0.28×x) wt. %), more preferably in the range from (70 wt. %−(0.2×x) wt. %) to (97 wt. %−(0.32×x) wt. %), based on the total weight of the cylinder.

According to an aspect 38, the present invention preferably relates to a particle-containing cylinder according to one of aspects 29 to 37, wherein the total quantity of particles and binders in the particle-containing cylinder is at least 90 wt. %, preferably at least 95 wt. %, more preferably at least 99.9 wt. %, based on the total weight of the cylinder.

According to an aspect 39, the present invention preferably relates to a particle-containing cylinder according to one of aspects 29 to 38, wherein the particles of the particle-containing cylinder are at least 90 wt. %, preferably at least 95 wt. %, more preferably at least 99.9 wt. % selected from either metal particles or glass particles or mica particles or ceramic particles, based on the total weight of the particles. Preferably the particles of the particle-containing cylinder are at least 90 wt. %, preferably at least 95 wt. %, more preferably at least 99.9 wt. %, selected from either metal particles or glass particles, more preferably metal particles, based on the total weight of the particles.

According to an aspect 40, the present invention preferably relates to a particle-containing cylinder according to one of aspects 29 to 39, wherein the particle-containing cylinder has a volume of at least 8 cm³, preferably of at least 11 cm³, more preferably of at least 19 cm³, still more preferably of at least 30 cm³.

According to an aspect 41, the present invention preferably relates to a particle-containing cylinder according to one of aspects 29 to 40, wherein the quantity of the binder in the particle-containing cylinder lies in a range from 0.05 wt. % to 70 wt. %, preferably in a range from 0.07 wt. % to 60 wt. %, more preferably in a range from 0.1 wt. % to 45 wt. %.

According to an aspect 42, the present invention preferably relates to a particle-containing cylinder according to one of aspects 29 to 41, wherein the particle-containing cylinder contains at least 1.5 wt. %, preferably at least 1.9 wt. %, more preferably at least 2.2 wt. %, of inorganic binder.

According to an aspect 43, the present invention preferably relates to a particle-containing cylinder according to one of aspects 29 to 42, wherein the inorganic binder is selected from the group consisting of calcium sulphate and silicon oxide.

According to an aspect 44, the present invention preferably relates to a particle-containing cylinder according to one of aspects 29 to 43, wherein the particle-containing cylinder contains at least 0.05 wt. %, preferably at least 0.07 wt. %, more preferably at least 0.1 wt. %, of organic binder.

According to an aspect 45, the present invention preferably relates to a particle-containing cylinder according to one of aspects 29 to 44, wherein the organic binder is selected from the group consisting of cellulose derivatives and polysaccharides. Preferably the organic binder is selected from the group consisting of starch and cellulose derivatives such as methylcellulose and ethylcellulose.

According to an aspect 46, the present invention preferably relates to a particle-containing cylinder according to one of aspects 29 to 45, wherein at least one binder of the particle-containing cylinder is selected from the group consisting of calcium sulphate, talc, calcium carbonate, silicon oxide, mixtures of calcium silicate hydrates and calcium aluminate hydrates, mixtures of calcium hydroxide and calcium carbonate, cellulose, cellulose derivatives, polysaccharides, polyvinyls, polyacrylates, polyethylene oxides, polyethylene glycols, polyamides, the salts of the aforesaid substances and mixtures thereof, preferably from the group consisting of calcium sulphate, silicon oxide, cellulose, cellulose derivatives, polysaccharides, polyvinyls, the salts of the aforesaid substances and mixtures thereof, more preferably from the group consisting of calcium sulphate, silicon oxide, cellulose derivatives, polysaccharides, the salts of the aforesaid substances and mixtures thereof. In particular it is preferable that the binder is selected from the group consisting of calcium sulphate and cellulose derivatives.

According to an aspect 47, the present invention preferably relates to a particle-containing cylinder according to one of aspects 29 to 46, wherein the particles of the particle-containing cylinder are at least 75 wt. %, preferably at least 87 wt. %, more preferably at least 98 wt. % metal particles, based on the total weight of the particles.

According to an aspect 48, the present invention preferably relates to a particle-containing cylinder according to one of aspects 29 to 47, wherein the metal of the metal particles is at least 90 wt. % selected from the group consisting of aluminium, copper, tin, zinc, iron, silver, titanium, nickel, gold, platinum, magnesium, tungsten, molybdenum, vanadium, mixtures thereof and alloys thereof.

According to an aspect 49, the present invention preferably relates to a particle-containing cylinder according to one of aspects 29 to 48, wherein the metal of the metal particles is at most 5 wt. %, more preferably at most 2 wt. %, more preferably at most 1 wt. %, selected from the group consisting of silver, palladium, platinum, gold, mixtures thereof and alloys thereof.

According to an aspect 50, the present invention preferably relates to a particle-containing cylinder according to one of aspects 29 to 49, wherein the metal particles are selected from uncoated metal particles and coated metal particles, wherein the quantity of the coating is on average at most 15 wt. %, preferably at most 12 wt. %, more preferably at most 10 wt. %, based on the total weight of the coated metal pigments.

According to an aspect 51, the present invention preferably relates to the use of a particle-containing cylinder for creating a particle-containing aerosol, wherein the cylinder has a volume of at least 5 cm³ and is dimensionally stable,

the content of particles lies in the range from 10 wt. % to 99.9 wt. %, based on the total weight of the cylinder,
the bending strength σ is at most 3.75 N/mm², more preferably at most 2.1 N/mm², still more preferably at most 1.2 N/mm², still more preferably at most 0.675 N/mm², where σ is calculated according to formula (I)

$$σ = \frac{3 \times F \times l}{2 \times B \times {D}^{2}} \qquad ( I )$$

where F=maximum force, B=width of the cylinder in rectangular shape, D=height of the cylinder in rectangular shape, l=distance between the two points of support,
the particles are selected from the group consisting of metal particles, glass particles, mica particles, ceramic particles and mixtures thereof,
the particles contained in the cylinder have a d₅₀ of at most 300 μm and
the cylinder contains at least 0.01 wt. % of binder, based on the total weight of the particle-containing cylinder, where the binder is selected from the group consisting of inorganic binders, organic binders and mixtures thereof. Preferably, the particle-containing aerosol is used in a coating method which is selected from the group consisting of cold gas spraying, flame spraying, high velocity flame spraying, thermal plasma spraying and non-thermal plasma spraying, preferably from the group consisting of thermal plasma spraying and non-thermal plasma spraying. In particular it is preferable that the coating process is non-thermal plasma spraying.

According to an aspect 52, the present invention preferably relates to the use according to aspect 51, wherein the inorganic binders are selected from the group consisting of calcium sulphate, talc, calcium hydroxide, silicon oxide, aluminium oxide, calcium carbonate, calcium silicate hydrates, calcium aluminate hydrates and mixtures thereof.

According to an aspect 53, the present invention preferably relates to the use according to one of aspects 51 to 52, wherein the organic binders are selected from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, more preferably from the group consisting of cellulose, cellulose derivatives, polysaccharides, gelatine, polyvinyls, polyacrylates, polyethylene oxides, polyethylene glycols, polyamides, epoxy resins, polyurethanes, polyacrylate copolymers, polyaldehyde copolymers, polyesters, polyolefin copolymers, the salts of the aforesaid substances and mixtures thereof, still more preferably from the group consisting of cellulose, cellulose derivatives, polysaccharides, gelatine, polyvinyls, polyacrylates, polyethylene oxides, polyethylene glycols, polyamides, epoxy resins, salts of the aforesaid substances and mixtures thereof.

According to an aspect 54, the present invention preferably relates to the use according to one of aspects 51 to 53, wherein a cylinder according to one of aspects 29 to 50 is used.

According to an aspect 55, the present invention relates to a coated object, wherein the coating took place using an aerosol which was generated by means of a method according to one of aspects 1 to 28 and/or using at least one cylinder according to one of aspects 29 to 50.

### FIGURES

FIG. 1: schematic layout of the measurement of the bending strength (1=particle-containing cylinder, 2=support rods, 3=loading rod)

FIG. 2: Curve of the three point measurement of a cylinder according to example 1-13 (force in N (y axis) against traverse distance in mm (x axis))

FIG. 3: SEM micrograph perpendicular to the coating of a coated glass slide, where this had been broken apart in the region of the coating. Best fit lines were laid through the base surface and the surface of the coating. The thickness of the coating is 25 μm.

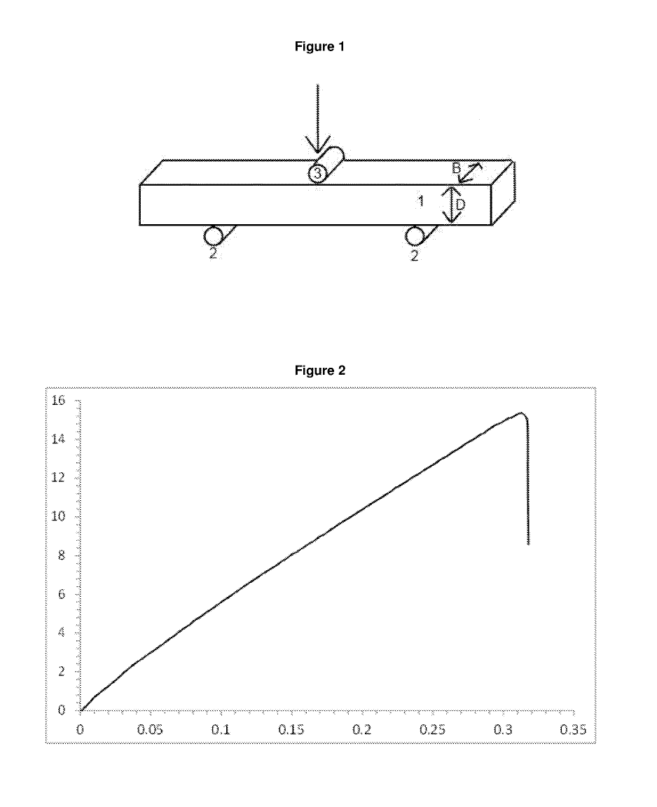

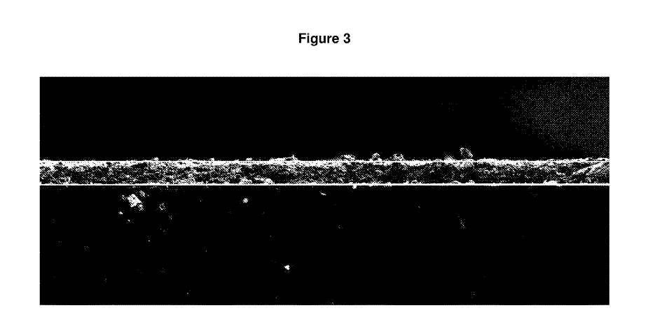

### EXAMPLE 1: PRODUCTION OF PARTICLE-CONTAINING CYLINDERS USING PLASTER

Plaster of the type A/Quick Rock Class 4 (Quick Dental Co.) or type B/Quick Dur S (Quick Dental Co.) and various particles according to table 1 were firstly mixed together and then mixed with deionized water (demineralized water) and ethanol. The now readily flowable material was introduced into a cylindrical mould lined with paper (circular base area, diameter 32 mm). After the cylinder was sufficiently hardened to be dimensionally stable, it was removed from the mould. Next, the cylinder obtained was dried in a drying cabinet at 50° C.

TABLE 1
Particle-containing cylinders with binder plaster: CE: comparative example,
Ex.: Example, (G): non-flaky particles, (F): flaky particles

| | | | Quantity | | | | Bending | |
|---|---|---|---|---|---|---|---|---|
| | | | of | | Deionized | | strength | |
| | Particle | d₅₀ | pigment | Plaster | water | EtOH | [N/mm²] | Observation |
| Ex. 1-1 | Copper (G) | 6 μm | 95 g | 6 g A | 20.0 g | 2.0 g | | |
| Ex. 1-2 | Copper (G) | 30 μm | 95 g | 6 g A | 15.0 g | 1.5 g | | |
| Ex. 1-3 | Aluminium (G) | 2 μm | 95 g | 6 g A | 30.0 g | 0.0 g | | |
| Ex. 1-4 | Copper (F) | 3 μm | 50 g | 54 g A | 77.2 g | 8.4 g | | |
| Ex. 1-5 | Copper (F) | 42 μm | 70 g | 32 g A | 65.0 g | 7.0 g | | |
| Ex. 1-6 | Brass (F) | 16 μm | 70 g | 32 g A | 95.0 g | 10.0 g | | |
| Ex. 1-7 | Copper- | 12 μm | 70 g | 32 g A | 105.0 g | 11.0 g | | |
| | nickel-zinc | | | | | | | |
| | alloy (F) | | | | | | | |
| Ex. 1-8 | Copper | 4 μm | 50 g | 54 g A | 77.2 g | 8.4 g | | |
| | coated with | | | | | | | |
| | silver (F) | | | | | | | |
| Ex. 1-9 | Copper (G) | 10 μm | 90 g | 12 g A | 26 g | 3.75 g | | |
| Ex. 1-10 | Copper (F) | 3 μm | 30 g | 32 g A | 45 g | 5.0 g | | |
| Ex. 1-11 | Copper (F) | 16 μm | 30 g | 77 g A | 95.0 g | 10.0 g | 0.72 | |
| Ex. 1-12 | Copper (F) | 16 μm | 70 g | 32 g A | 95.0 g | 10.0 g | 0.0195 | |
| Ex. 1-13 | Copper (F) | 16 μm | 50 g | 54 g B | 95.0 g | 10.0 g | 0.21 | |
| Ex. 1-14 | Copper (F) | 16 μm | 70 g | 32 g B | 95.0 g | 10.0 g | 0.3 | |
| Ex. 1-15 | Copper (G) | 6 μm | 150 g | 164 g A | 73.0 g | 25.0 g | 3.15 | |
| Ex. 1-16 | Copper (G) | 6 μm | 150 g | 164 g B | 73.0 g | 25.0 g | 2.4 | |
| Ex. 1-17 | Copper (G) | 6 μm | 210 g | 99 g B | 73.0 g | 25.0 g | 1.1 | |
| Ex. 1-18 | Copper (G) | 6 μm | 270 g | 32 g A | 73.0 g | 25.0 g | 0.22 | |
| Ex. 1-19 | Copper (G) | 6 μm | 270 g | 32 g B | 73.0 g | 25.0 g | 0.14 | |
| Ex. 1-20 | Copper (F) | 16 μm | 50 g | 30 g A | 68.0 g | 17.0 g | | |
| | Tin (G) | 45 μm | 20 g | | | | | |
| Ex. 1-21 | Copper (G) | 10 μm | 60 g | 30 g A | 68.0 g | 17.0 g | | |
| | Tin (G) | 45 μm | 20 g | | | | | |
| Ex. 1-22 | Glass (F) | 20 μm | 84 g | 50 g A | 85.0 g | 0.0 g | | |
| Ex. 1-23 | Aluminium | 11 μm | 5 g | 95 g A | 75.0 g | 0.0 g | | |
| | oxide (F) | | | | | | | |
| CE 1-1 | Copper (G) | 10 μm | 95 g | 6 g A | 20.0 g | 2.5 g | | not |
| | | | | | | | | dimensionally |
| | | | | | | | | stable |
| CE 1-2 | Copper (G) | 6 μm | 98 g | 3 g A | 14 g | 1.4 g | | not |
| | | | | | | | | dimensionally |
| | | | | | | | | stable |
| CE 1-3 | Copper (F) | 16 μm | 80 g | 22 g A | 110.0 g | 11.3 g | | not |
| | | | | | | | | dimensionally |
| | | | | | | | | stable |
| CE 1-4 | Copper (F) | 42 μm | 80 g | 22 g A | 73.0 g | 8.0 g | | not |
| | | | | | | | | dimensionally |
| | | | | | | | | stable |
| CE 1-5 | Brass (F) | 16 μm | 80 g | 22 g A | 110.0 g | 11.3 g | | not |
| | | | | | | | | dimensionally |
| | | | | | | | | stable |

TABLE 2
Average densities from Example 1-17

| | Piece 1 | Piece 2 | Piece 3 |
|---|---|---|---|
| Disc 1 | 4.59 g/cm³ | 4.56 g/cm³ | 4.53 g/cm³ |
| Disc 2 | 4.57 g/cm³ | 4.57 g/cm³ | 4.53 g/cm³ |
| Disc 3 | 4.50 g/cm³ | 4.57 g/cm³ | 4.52 g/cm³ |

### EXAMPLE 2: PRODUCTION OF PARTICLE-CONTAINING CYLINDERS USING ETHYLCELLULOSE

Ethocel Standard 200 Premium (Example 2-1, DOW), Aqualon Ethylcellulose N100 (Example 2-2, Ashland) or Ethocel Std 300 Industrial (Example 2-3, DOW) and particles were first mixed together and then with acetone. The material was introduced into a cylindrical mould lined with paper (circular base area, diameter 32 mm). After the cylinder had hardened sufficiently to be dimensionally stable, it was removed from the mould. Next, the cylinder obtained was dried in a drying cabinet at 50° C.

TABLE 3
Particle-containing cylinder with binder ethylcellulose:
Ex.: Example, (G): non-flaky particles

| | Particle | d₅₀ | Pigment | Ethylcellulose | Acetone |
|---|---|---|---|---|---|
| Ex. 2-1 | Tin (G) | 15 μm | 199.9 g | 0.3 g | 14.0 g |
| Ex. 2-2 | Tin (G) | 15 μm | 199.9 g | 0.3 g | 14.0 g |
| Ex. 2-3 | Tin (G) | 15 μm | 199.9 g | 0.3 g | 14.0 g |

### EXAMPLE 3: PRODUCTION OF PARTICLE-CONTAINING CYLINDERS USING MICROCRYSTALLINE CELLULOSE

Avicel PH-101 and particles were first mixed together and then filled into a tablet press of the Vaneox type (Fluxana Co.). The compression was performed in pressing tools with a diameter of 40 mm by means of a pressure of 3 tons for 10 seconds.

TABLE 4
Particle-containing cylinders with binder microcrystalline cellulose:
Ex.: Example, (G): non-flaky particles

| | Particle | d₅₀ | Pigment | Avicel PH-101 |
|---|---|---|---|---|
| Ex. 3-1 | Tin (G) | 15 μm | 24.00 g | 1.0 g |
| Ex. 3-2 | Tin (G) | 15 μm | 24.25 g | 0.75 g |
| Ex. 3-3 | Tin (G) | 15 μm | 24.5 g | 0.50 g |
| Ex. 3-4 | Tin (G) | 15 μm | 24.75 g | 0.25 g |
| Ex. 3-5 | Tin (G) | 15 μm | 23.75 g | 1.25 g |
| Ex. 3-6 | Tin (G) | 15 μm | 24.88 g | 0.12 g |
| Ex. 3-7 | Tin (G) | 15 μm | 24.90 g | 0.10 g |
| Ex. 3-8 | Tin (G) | 15 μm | 24.93 g | 0.07 g |
| Ex. 3-9 | Tin (G) | 15 μm | 24.25 g | 0.75 g |
| Ex. 3-10 | Tin (G) | 15 μm | 1.25 g | 3.75 g |
| Ex. 3-11 | Tin (G) | 15 μm | 5.00 g | 5.00 g |
| Ex. 3-12 | Tin (G) | 15 μm | 7.50 g | 2.50 g |
| Ex. 3-13 | Tin (G) | 15 μm | 13.50 g | 1.50 g |

### EXAMPLE 4: PRODUCTION OF PARTICLE-CONTAINING CYLINDERS USING VARIOUS BINDERS

The following binders were first mixed with the non-flaky metal particles (G: non-flaky particles, F: flaky particles) and then with solvent (E: ethanol, W: water, FA: 90% formic acid, EA: ethyl acetate). The material was introduced into a cylindrical mould lined with paper (circular base area, diameter 32 mm). After the cylinder had hardened sufficiently to be dimensionally stable, it was removed from the mould. Next, the cylinders obtained were dried in a drying cabinet at 50° C. In experiment 4-1, drying was then performed at 70° C. In experiment 4-2, drying was performed at 170° C.

TABLE 5
Particle-containing cylinders with various binders

| | Particle | d₅₀ | Pigment | Binder | Solvent |
|---|---|---|---|---|---|
| Ex. 4-1 | Copper (G) | 15 μm | 195 g | 5 g Acronal 12 DE | 15 g W |
| Ex. 4-2 | Copper (G) | 15 μm | 195 g | 5 g Acronal S747 S | 15 g W |
| Ex. 4-3 | Copper (G) | 15 μm | 195 g | 5 g Acrodur DS 3530 | 15 g W |
| Ex. 4-4 | Copper (G) | 15 μm | 195 g | 5 g cellulose | 15 g W |
| | | | | Thickener C 6000 | |
| Ex. 4-5 | Copper (G) | 15 μm | 195 g | 5 g Gelita Imagel | 15 g W |
| Ex. 4-6 | Copper (G) | 15 μm | 195 g | 5 g Polyglycol 10000 S | 15 g W |
| Ex. 4-7 | Copper (G) | 15 μm | 195 g | 5 g Polyglycol 1500 S | 15 g W |
| Ex. 4-8 | Copper (G) | 15 μm | 195 g | 5 g Ultramid A | 15 g FA |
| Ex. 4-9 | Copper (G) | 15 μm | 198 g | 2 g Sakret PU | — |
| Ex. 4-10 | Copper (G) | 15 μm | 198 g | 2 g Epoxy resin binder 2000 EP | — |
| Ex. 4-11 | Copper (G) | 15 μm | 95 g | 5 g Laropal A 101 | 300 g E |
| Ex. 4-12 | Copper (G) | 15 μm | 97 g | 3 g Laropal A 101 | 300 g E |
| Ex. 4-13 | Copper (G) | 15 μm | 98 g | 2 g Laropal A 101 | 300 g E |
| Ex. 4-14 | Copper (G) | 15 μm | 97.5 g | 2.5 g Laropal A 101 | 50 g E |
| Ex. 4-15 | Copper (G) | 15 μm | 98.5 g | 1.5 g Laropal A 101 | 50 g E |
| Ex. 4-16 | Copper (G) | 15 μm | 97.5 g | 2.5 g Resin CA 0002 | 50 g E |
| Ex. 4-17 | Copper (G) | 15 μm | 98.5 g | 1.5 g Resin CA 0002 | 50 g E |
| Ex. 4-18 | Copper (G) | 15 μm | 99 g | 1 g Resin CA 0002 | 50 g E |
| Ex. 4-19 | Copper (G) | 15 μm | 97.5 g | 2 g Degalan P24 | 50 g EA |
| Ex. 4-20 | Copper (G) | 15 μm | 99 g | 2 g Degalan P24 | 50 g EA |
| Ex. 4-21 | Copper (G) | 15 μm | 97.5 g | 2.5 g CAB 531-1 | 40 g E |
| Ex. 4-22 | Copper (G) | 15 μm | 95 g | 5 g CAB 531-1 | 40 g E |
| Ex. 4-23 | Copper (G) | 15 μm | 99 g | 1 g Butavar B-76 | 50 g E |
| Ex. 4-24 | Copper (G) | 15 μm | 98.5 g | 1.5 g Butavar B-76 | 50 g E |
| Ex. 4-25 | Copper (G) | 15 μm | 98 g | 1 g Butavar B-76 | 50 g E |
| Ex. 4-26 | Copper (G) | 15 μm | 98 g | 2 g Butavar B-76 | 50 g E |
| Ex. 4-27 | Copper (G) | 15 μm | 195 g | 5 g Acronal 32 D | 15 g W |
| Ex. 4-28 | Copper (G) | 15 μm | 195 g | 5 g Styrofan D 780 S | 15 g W |
| Ex. 4-29 | Copper (G) | 15 μm | 195 g | 5 g Urecoll 135 | 15 g W |
| Ex. 4-30 | Copper (G) | 15 μm | 195 g | 5 g Saduren 163 | 15 g W |
| Ex. 4-31 | Copper (G) | 15 μm | 195 g | 5 g Acronal S 888 S | 15 g W |
| Ex. 4-32 | Copper (G) | 15 μm | 195 g | 5 g Acrodur DS 3515 | 15 g W |
| Ex. 4-33 | Copper (G) | 15 μm | 195 g | 5 g Acronal LN 838 S | 15 g W |
| Ex. 4-34 | Copper (G) | 15 μm | 195 g | 5 g Acronal LN 579 S | 15 g W |

Acronal 12 DE, Acronal S747 S (Polyacrylate), Acronal 32 D, Styrofan D 780 S, Urecoll 135, Saduren 163, Acrodur DS 3530, Acronal LN 838 S, Acrodur DS 3515, Acronal LN 579 S, Acronal S 888 S and Ultramid A (polyamide) are marketed by BASF. Cellulose thickener C 6000 (sodium carboxyethylcellulose) is marketed by Kremer Pigments. Gelita Imagel is marketed by the company Gelita. Polyglycol 10000 S and Polyglycol 1500 S are marketed by the company Clariant. Sakret PU is marketed by the company SAKRET Trockenbaustoffe Europa GmbH & Co. KG. Epoxy resin binder 2000 EP is marketed by the company Solipur—Höfer & Stankowska GbR. CAB 531-1 (cellulose acetate butyrate) is marketed by the company Eastman. Butavar B-76 (polyvinylbutyral) is marketed by Eastman Chemical B.V. Degalan P24 (polyacrylate) is marketed by Evonik.

In initial evaluations, the cylinders obtained were found suitable for the method according to the invention.

### EXAMPLE 5: PRODUCTION OF PARTICLE-CONTAINING CYLINDERS USING ACRYLATE MONOMERS

0.5 g of dimethyl-2.2′-azobis(2-methylpropionate) (Trade name V 601; available from WAKO Chemicals GmbH, Fuggerstraβe 12, 41468 Neuss) and 10 g of trimethylolpropane trimethacrylate are mixed in 50 ml isopropanol. The solution obtained is mixed with 190 g of non-flaky copper particles (d₅₀=15 μm) and introduced into a cylindrical mould lined with paper (circular base area, diameter 32 mm). Next, the cylinder is hardened for 3 hrs at 90° C. In initial evaluations, the cylinders obtained were found suitable for the method according to the invention.

### APPLICATION EXAMPLE 1: DISPERSION

Cylinders according to the invention were converted into an aerosol by means of an aerosol generator (Palas RBG 10001). The aerosol stream generated was collected and the solid particles contained therein were measured in a particle size measuring instrument HELOS from the company Sympatec GmbH, Clausthal-Zellerfeld, Germany. Further, the particle material incorporated in the cylinders was dispersed by means of a disperser unit of the Rodos T4.1 type at a primary pressure of for example 4 bar and measured. The assessment of the scattered light signals was performed by the Fraunhofer method.

TABLE 6
Dispersion experiments

| | Average particle size of | Average particle size of |
|---|---|---|
| Experiment | aerosol collected | particles obtained |
| Example 1-10 | 7 μm | 3 μm |
| Example 1-12 | 24 μm | 16 μm |
| Example 2-1 | 29 μm | 15 μm |

1. A method for the production of a particle-containing aerosol, comprising,
comminutating a particle-containing cylinder,
wherein the particle-containing cylinder has a volume of at least 5 cm³ and is dimensionally stable,
the content of particles of the particle-containing cylinder lies in the range from 10 wt. % to 99.9 wt. %, based on the total weight of the particle-containing cylinder,
the bending strength σ, of the particle-containing cylinder, is at most 3.75 N/mm², where σ is calculated according to formula (I)
$$σ = \frac{3 \times F \times l}{2 \times B \times {D}^{2}} \qquad ( I )$$
where F=maximum force, B=width of the particle-containing cylinder in rectangular shape, D=height of the particle-containing cylinder in rectangular shape, l=distance between the two points of support,
the particles are selected from the group consisting of metal particles, glass particles, mica particles, ceramic particles, and mixtures thereof,
the particles contained in the particle-containing cylinder have a d₅₀ of at most 300 μm, and the particle-containing cylinder contains at least 0.01 wt. % of binder, based on the total weight of the particle-containing cylinder, where the binder is selected from the group consisting of inorganic binders, organic binders, and mixtures thereof.

2. The method of claim 1, wherein the inorganic binder is selected from the group consisting of calcium sulphate, talc, calcium hydroxide, silicon oxide, aluminium oxide, calcium carbonate, calcium silicate hydrates, calcium aluminate hydrates, and mixtures thereof.

3. The method of claim 1, wherein the organic binder is selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polycarbonyl copolymers, polyesters, polyolefin copolymers, salts of the aforesaid substances, and mixtures thereof.

4. The method of claim 1, wherein the particle-containing cylinder has a bending strength of at least 0.0075 N/mm².

5. The method of claim 1, wherein the particle-containing cylinder contains at least 1.5 wt. % of inorganic binder or at least 0.01 wt. % of organic binder.

6. The method of claim 1, wherein the content of non-flaky particles in the particle-containing cylinder lies in a range from 50 wt. % to 99.9 wt. %, in each case based on the total weight of the particle-containing cylinder.

7. The method of claim 1, wherein the content of flaky particles in the particle-containing cylinder lies in a range from 30 wt. % to 75 wt. %, in each case based on the total weight of the particle-containing cylinder.

8. The method of claim 1, wherein the total quantity of particles and binders in the particle-containing cylinder is at least 90 wt. %, based on the total weight of the particle-containing cylinder.

9. The method of claim 1, wherein the quantity of the binder in the particle-containing cylinder lies in a range from 0.05 wt. % to 70 wt. %, based on total weight of the particle-containing cylinder.

10. The method of claim 1, wherein at least one binder of the particle-containing cylinder is selected from the group consisting of calcium sulphate and cellulose derivatives.

11. The method of claim 1, wherein the particles of the particle-containing cylinder are at least 75 wt. % metal particles, based on the total weight of the particles.

12. A method of coating a substrate, comprising the following steps,
a) providing a particle-containing aerosol prepared by the method of claim 1,
b) depositing the particles of the particle-containing aerosol on a substrate by a coating method which is selected from the group consisting of cold gas spraying, flame spraying, high velocity flame spraying, thermal plasma spraying, and non-thermal plasma spraying.

13. A particle-containing cylinder comprising particles,
wherein the particle-containing cylinder has a volume of at least 5 cm³ and is dimensionally stable,
the content of particles lies in the range from 10 wt. % to 99.9 wt. %, based on the total weight of the particle-containing cylinder,
the bending strength σ, of the particle-containing cylinder, is at most 3.75 N/mm², where σ is calculated according to formula (I),
$$σ = \frac{3 \times F \times l}{2 \times B \times {D}^{2}} \qquad ( I )$$
where F=maximum force, B=width of the particle-containing cylinder in rectangular shape, D=height of the particle-containing cylinder in rectangular shape, l=distance between the two points of support,
the particles are selected from the group consisting of metal particles, glass particles, mica particles, ceramic particles and mixtures thereof,
the particles contained in the particle-containing cylinder have a d₅₀ of at most 300 μm and the particle-containing cylinder contains at least 0.01 wt. % of binder, based on the total weight of the particle-containing cylinder, where the binder is selected from the group consisting of inorganic binders, organic binders and mixtures thereof.

14. The particle-containing cylinder of claim 13, wherein the particle-containing cylinder has a bending strength of at least 0.0075 N/mm²,
the inorganic binder is selected from the group consisting of calcium sulphate, talc, calcium hydroxide, silicon oxide, aluminium oxide, calcium carbonate, calcium silicate hydrates, calcium aluminate hydrates, and mixtures thereof, and
the organic binder is selected from the group consisting of cellulose, cellulose derivatives, polysaccharides, gelatine, polyvinyls, polyacrylates, polyethylene oxides, polyethylene glycols, polyamides, epoxy resins, polyurethanes, polyaldehydes, polyolefins, polyacrylate copolymers, polyaldehyde copolymers, polycarbonyl copolymers, polyesters, polyolefin copolymers, the salts of the aforesaid substances, and mixtures thereof.

15. A particle-containing aerosol prepared by a method comprising,
comminutating a particle-containing cylinder,
wherein the particle-containing cylinder has a volume of at least 5 cm³ and is dimensionally stable,
the content of particles lies in the range from 10 wt. % to 99.9 wt. %, based on the total weight of the particle-containing cylinder,
the bending strength σ, of the particle-containing cylinder, is at most 3.75 N/mm², where σ is calculated according to formula (I),
$$σ = \frac{3 \times F \times l}{2 \times B \times {D}^{2}} \qquad ( I )$$
where F=maximum force, B=width of the particle-containing cylinder in rectangular shape, D=height of the particle-containing cylinder in rectangular shape, l=distance between the two points of support,
the particles are selected from the group consisting of metal particles, glass particles, mica particles, ceramic particles, and mixtures thereof,
the particles contained in the particle-containing cylinder have a d₅₀ of at most 300 μm, and the particle-containing cylinder contains at least 0.01 wt. % of binder, based on the total weight of the particle-containing cylinder, where the binder is selected from the group consisting of inorganic binders, organic binders and mixtures thereof.
